(19) United States
(12) Patent Application Publication
(10) Pub. No.: US 2009/0155421 A1
(43) Pub. Date: Jun. 18, 2009

(54) Edible livestock feeding container

(76) Inventor: David W. Berry, Perry, MO (US)

Correspondence Address: LAW OFFICE OF JOHN C. MCMAHON, P.O. BOX 30069, KANSAS CITY, MO, 64112, US

(21) Appl. No.: 12/313,525

(22) Filed: Nov. 22, 2008

Related U.S. Application Data
(60) Provisional application No. 61/007,372, filed on Dec. 12, 2007.

(51) Int. Cl. A23L 1/304; B65D 81/36; A23P 1/10

(52) U.S. Cl. 426/74; 426/138; 426/656

(57) ABSTRACT

An injection molded livestock feed container that is biodegradable, edible and of feed-grade nutritional value is made from a mixture that includes corn gluten, magnesium oxide and glycerine and may further include calcium carbonate and fiber, such as soybean hulls, cotton seed hulls and sunflower hulls. The mixture is dry mixed and injection molded to form the container.

### CROSS-REFERENCE TO RELATED APPLICATION

This application claims the benefit of U.S. Provisional Patent Application Ser. No. 61/007,372, filed Dec. 12, 2007, which is incorporated by reference herein.

### BACKGROUND OF THE INVENTION

The present invention is directed to improved apparatus and methods for making livestock feeding containers, and in particular to an edible feed-grade container for feeding grain and other food to livestock.

Livestock feed and feed supplements, such as mineral mixes, are often provided in metal or plastic containers that are durable and may be returnable. Livestock feed supplements are also sold in paper or cardboard containers. A draw-back to more sturdy containers, such as those made from steel, is that such containers are typically returnable, which although good for the environment, requires the user's precious time, effort and expense in collecting and returning the containers. Plastic containers must also be collected, either for return or for disposal. A danger presented by some plastic containers is that they may also be consumed by the livestock if not collected soon after use. Plastic and fiber or cardboard containers may also be fairly light in weight after the feed or feed supplement is consumed, and may be blown by the wind to other locations, causing further time and effort in collection and disposal.

It is known to provide livestock feed supplements in containers that are biodegradable and edible. Such containers typically utilize a large amount of fiber, primarily straw that is mixed with a soy or other flour solution for binding. Such straw-based containers are strong, but typically are thick-walled and have little or no dietary value. In fact, some animals refuse to eat such containers, resulting in all or parts of such containers littering the environment until such time as degradation occurs. Other known biodegradable feed packages or containers that do not include large amounts of straw or other types of stalks, have been found to be of inferior strength, exhibiting cracks and other defects that result in mechanical breakage or other failure during shipping and handling of the containers. Thus, it is desirable to provide a livestock feed or feed supplement container that is not only edible and strong, but relatively thin-walled, palatable to livestock and has nutritional value.

### SUMMARY OF THE INVENTION

A molded livestock feed container according to the invention that is biodegradable, edible and has feed-grade nutritional value is made from a composition formed from a mixture that includes gluten, magnesium oxide and glycerine. The mixture may further include calcium carbonate and fiber, such as soybean hulls, cotton seed hulls and sunflower hulls. The mixture is injection molded to form the feed container.

### OBJECTS AND ADVANTAGES OF THE INVENTION

Therefore, objects of the present invention include: providing methods and apparatus for containing livestock feed and feed supplements; providing such methods and apparatus that result in containers that are edible and palatable to animals; providing such methods and apparatus that result in containers with nutritional value; providing such methods and apparatus that result in strong but relatively thin-walled containers; providing such methods and apparatus that are inexpensive to produce and especially well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a front elevational view of a feeding container according to the invention.

FIG. 2 is a top plan view of the feeding container of FIG. 1.

FIG. 3 is an enlarged cross-sectional view, taken along the line 3-3 of FIG. 2 with a contained feed supplement shown in phantom.

FIG. 4 is a perspective view of a second embodiment of a feeding container according to the invention.

FIG. 5 is a reduced perspective view of the feeding container of FIG. 4 shown with a cow.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

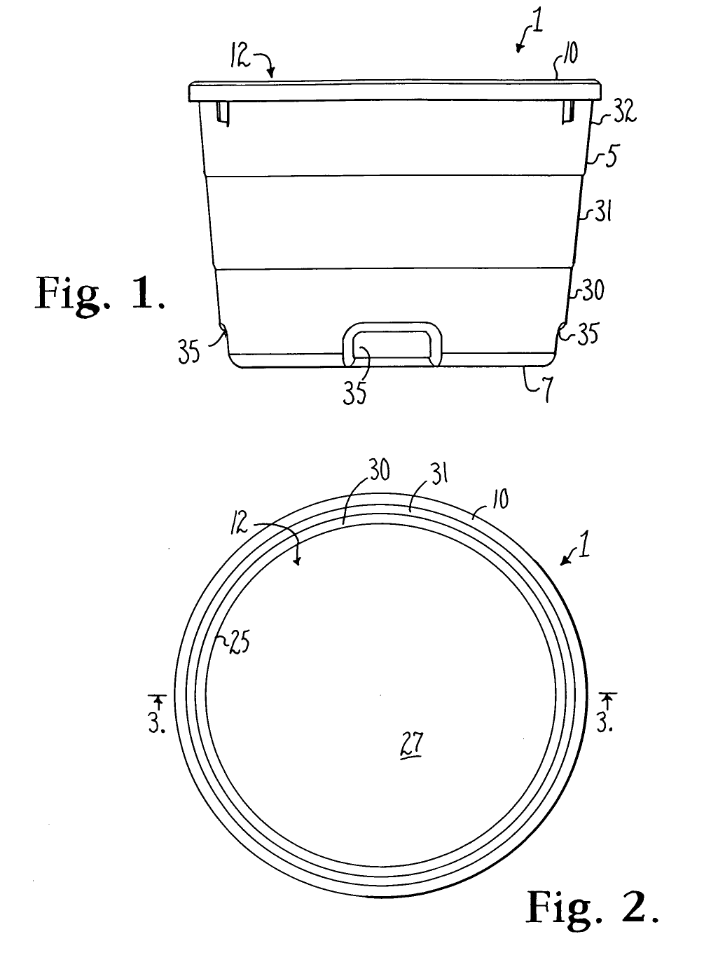

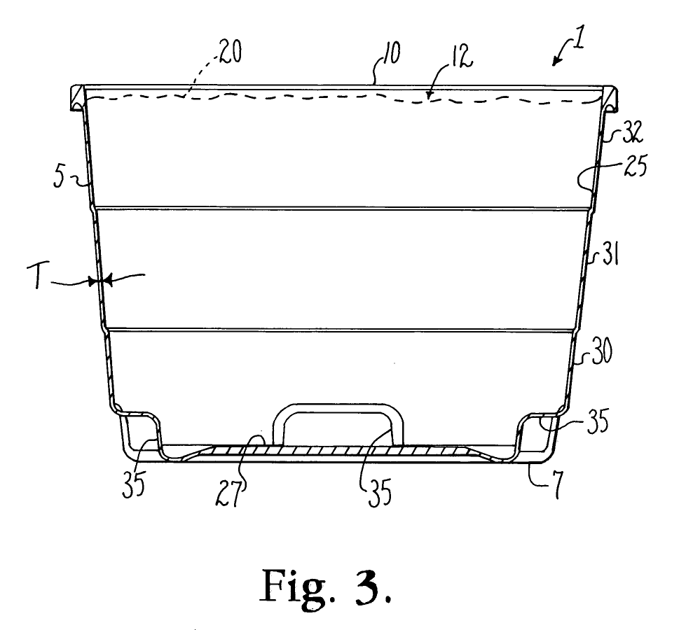

With reference to FIGS. 1-3, the reference numeral 1 generally designates a molded livestock feeding container made with a composition according to the invention. The illustrated container 1 is round, with a bowl, tub or bucket shape, defined by a substantially cylindrical or a frusto-conical retaining wall 5 integral with a substantially planar and circular base 7. The container 1 has an upper substantially circular and annular rim or top surface 10 defining an opening 12. As illustrated in FIG. 3, feed or feed supplements 20 (shown in phantom) are contained by an inner surface 25 of the wall 5 and a bottom surface 27 of the base 7. In particular, the illustrated container wall 5 includes three graduated sections 30, 31 and 32, each frusto-conical in form, with section 30 having a lower diameter approximately equal to an outer diameter of the base 7 that is adjacent to the section 30; the section 31 having a lower diameter slightly larger than an upper diameter of the adjacent section 30; and the section 32 having a lower diameter slightly larger than an upper diameter of the adjacent section 31. The section 32 is adjacent to the rim 10. Formed in the base 7 and the section 30 are four recessed areas 35, useful for storing, carrying and manipulation of the container 1. The illustrated embodiment is about 15.43 inches tall, and about 21.66 inches in diameter with a wall thickness T of about 0.13 inches. Containers of the invention preferably have a wall thickness ranging between about 0.005 and about 1.0 inch.

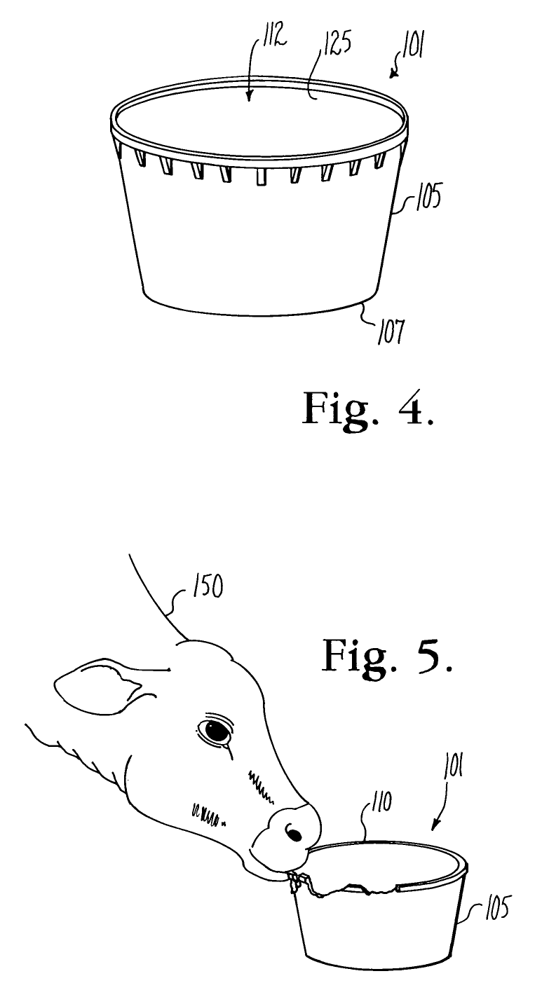

It is noted that although a curved or round, molded container 1 is illustrated, containers according to the invention are not limited to the particular shape of the container 1 and may be of a variety of geometric shapes and sizes. Also, with reference to FIGS. 4 and 5, a second embodiment of a feeding container according to the invention, generally 101 is illustrated that is also bowl-shaped, but of simpler design than the container 1. The container 101 has an upper substantially circular and annular rim or top surface 110 defining an opening 112. Feed or feed supplements are contained by an inner surface 125 of a wall 105 and a bottom surface of a base 107. Unlike the container 1, the curved wall 105 of the container 101 is made from a single frusto-conical section. In FIG. 5, the container 101 is again illustrated, with portions of the rim 110 and wall 105 being consumed by a cow 150.

Compositions according to the invention used to make the container 1 or the container 101 according to the invention include gluten, magnesium oxide and glycerine and may further include calcium carbonate. Preferably, compositions according to the invention include the following: between about 30 wt. % and about 70 wt. % gluten; between about 20 wt. % and about 50 wt. % of magnesium oxide; between about 7 wt. % and about 30 wt. % glycerine; between about 0 wt. % and about 10 wt. % of calcium carbonate; and between about 0 wt. % and about 40 wt. % of a fiber.

The gluten component of the inventive composition is preferably corn gluten. As stated above, a preferred range of corn gluten in the composition is between about 30 wt. % and about 70 wt. %; with a particularly preferred range being between about 30 wt. % and about 60 wt. %; and a most particularly preferred amount at about 42 wt. %. Wheat and other grain gluten may also be utilized in compositions of the invention. The use of corn or wheat gluten in the inventive composition and resulting molded container provides a high protein, one hundred percent feed grade container as compared to other known livestock containers made from straw or stalk that may only be partially eaten by the livestock and have no food value. Containers 1 and 101 according to the invention made with corn gluten have tested at or above 27 wt. % protein after molding (that is at least equivalent to the amount of protein present in some of the feed or feed supplements being contained thereby).

The magnesium oxide component (MgO₂) of compositions according to the invention may range between about 10 wt. % and about 50 wt. %; preferably ranges between about 20 wt. % and about 50 wt. %; and is most preferably present in an amount of about 23 wt. % of the dry blend composition. It is believed that the magnesium oxide aids in binding the protein to the mixture during molding, resulting in a stiffer final product than a similar product molded in the absence of magnesium oxide.

The glycerin component of compositions according to the invention preferably ranges between about 7 wt. % and about 30 wt. %; and is most preferably present in an amount of about 13 wt. % of the dry blend composition. Glycerin gives some bendability and flexibility to the final product. The glycerin component may be in powder or liquid form.

A vegetable oil may be added to the mixture and the glycerin amount may be reduced. However, in certain processes according to the invention, the addition of vegetable oil has caused the screw or worm mixer to turn at erratic rates. Vegetable oils aid in keeping the gluten from drying out during processing, but also makes molding more difficult.

The calcium carbonate component of compositions according to the invention preferably ranges between about 0 wt. % and about 10 wt. %; and is most preferably present in an amount of about 4 wt. % of the dry blend composition. The calcium carbonate is useful as a lubricant during mixing and molding.

The fiber component of compositions according to the invention preferably ranges between about 0 wt. % and about 40 wt. %; and is most preferably present in an amount between about 20 wt. % and about 25 wt. %. Soybean hulls are preferred for the fiber component. Other fibrous materials useful in compositions of the invention include, but are not limited to cotton seed hulls, sunflower hulls and filings and rice hulls. Lignin may also be added to mixtures of the invention. It is believed that ammonium lignin in an amount of up to about 5 wt. % is also useful as a pest deterrent. Urea may also be added to the mixture.

The composition or mixture components are added together and mixed in a substantially dry process with no water being added. Thus, as some of the components may be in liquid form, the mixture is typically damp, but not liquid. For example, the components may be mixed in a batch or screw type mixer at or about 180 deg. F. When a screw-type mixer is used, the mixer does not purge well if the mixing temperature is below 180 deg. F. Then, the blend leaving the mixer is typically injection molded at a barrel temperature of between about 200 deg. F. and about 275 deg. F. to form the container 1, 101 or other sizes and shapes of composite structures for holding feed and/or feed supplements. It is believed that molding to about 275 deg. F. is beneficial for killing bacteria. Other conventional molding techniques may also be used, including compression and transfer molding. Although hotter mixing and/or molding temperatures may be used, such are typically undesirable as high heat undesirably lowers the protein content of the feeding container. Preferably, containers of the invention are injection molded with just enough heat added to coagulate and bond the component materials of the composition of the invention without compromising protein content of the final molded product. Molding pressures of between about 8000 p.s.i. and about 27000 p.s.i. are preferred.

An example of a composition according to the invention follows:

The following components were mixed together in a screw-type mixer at about 180 deg. F.:

| | |
|---|---|
| Corn Gluten | 42 wt. % |
| Soybean Hulls | 23 wt. % |
| Calcium Carbonate | 4 wt. % |
| Glycerine | 13 wt. % |
| Magnesium Oxide | 19 wt. % |

The resulting mixture was then injection molded at 11000 p.s.i. and 275 deg. F. to form the container 1 shown in FIG. 1 that had a protein content of 27% after molding.

It is to be understood that while certain forms of the present invention have been illustrated and described herein, it is not to be limited to the specific forms or arrangement of parts described and shown.

What is claimed and desired to be secured by Letters Patent is as follows:

1. An edible livestock feed container molded from a composition comprising:
a) gluten in an amount of at least about 30 wt. %;
b) magnesium oxide; and
c) glycerin.

2. The composition of claim 1 further comprising calcium carbonate.

3. The composition of claim 1 further comprising fiber.

4. The composition of claim 1 further comprising a fiber selected from the group consisting of soy bean hulls, cotton seed hulls, sunflower hulls, rice hulls, and mixtures thereof.

5. The composition of claim 1 comprising between about 30 wt. % and about 70 wt. % corn gluten; between about 20 wt. % and about 50 wt. % of magnesium oxide; and between about 7 wt. % and about 30 wt. % glycerine.

6. The composition of claim 5 further comprising up to about 10 wt. % of calcium carbonate.

7. The composition of claim 5 further comprising up to about 40 wt. % of a fiber.

8. A dry-blend composition for forming an edible composite of feed-grade nutritional value, the composition comprising:
a) corn gluten in an amount of at least about 30 wt. %;
b) magnesium oxide;
c) glycerin; and
d) calcium carbonate.

9. The composition of claim 8 comprising between about 30 wt. % and about 70 wt. % of the corn gluten; between about 20 wt. % and about 50 wt. % of the magnesium oxide; and between about 0.7 wt. % and about 30 wt. % the glycerine; and up to about 10 wt. % of the calcium carbonate.

10. The composition of claim 8 further comprising up to about 40 wt. % of a fiber.

11. The composition of claim 10 wherein the fiber is selected from the group consisting of soy bean hulls, cotton seed hulls, sunflower hulls, rice hulls, and mixtures thereof.

12. A method of forming an edible livestock feed container comprising:
a) mixing a dry blend of corn gluten, magnesium oxide and glycerin; and
b) injection molding the mixture of step a).

13. The method of claim 12 wherein the mixing step a) is performed at about 180 degrees F.

14. The method of claim 12 wherein the molding step b) is performed at between about 200 deg. F. and about 275 deg. F.
